(19) United States
(12) Patent Application Publication
(10) Pub. No.: US 2002/0081003 A1
(43) Pub. Date: Jun. 27, 2002

(54) System and method for automatically enhancing graphical images

(76) Inventor: Robert E. Sobol, Ft Collins, CO (US)

Correspondence Address: HEWLETT-PACKARD COMPANY, Intellectual Property Administration, P. O. Box 272400, Fort Collins, CO, 80527-2400, US

(21) Appl. No.: 09/749,165

(22) Filed: Dec. 27, 2000

(51) Int. Cl. G06K 9/00; G06K 9/36; G06T 5/00

(52) U.S. Cl. 382/118; 382/254

(57) ABSTRACT

An image enhancing system utilizes memory, a face detector, and an image enhancer. The memory stores digital data that defines a graphical image. The face detector analyzes the stored digital data and automatically identifies facial data within the digital data. This facial data defines an image of a person's face. The image enhancer analyzes the facial data and automatically identifies a portion of the facial data that defines a particular facial feature. The image enhancer then automatically manipulates the forgoing portion of the facial data in order to improve or enhance an appearance of the facial feature when the facial feature is displayed by a display device.

### BACKGROUND OF THE INVENTION

1. Field of the Invention

The present invention generally relates to image processing techniques and, in particular, to a system and method for automatically detecting and manipulating data that defines a facial feature within a digital image in order to enhance an appearance of the facial feature.

2. Related Art

Various photography enhancement techniques exist for improving the appearance of a person within a photographed image. For example, techniques for removing or de-emphasizing blemishes, wrinkles and other anomalies from a photographed face have existed for many years. Normally, a photograph of a person is taken by exposing an image of the person to a photosensitive material, thereby capturing the image on a “negative” of the photograph. A trained photographer then develops the negative via techniques well known in the art.

During developing, the photographer analyzes the image captured by the negative to determine if there are any unsightly features within the image that should be removed, faded, or otherwise de-emphasized. If such features are found, the features can be selectively removed or de-emphasized via air brushing or other techniques well known in the art to improve the appearance of the person within the developed picture.

Unfortunately, such image enhancing requires a trained photographer to analyze and enhance the negative of the captured image. Having a trained photographer analyze and enhance the negative of a picture increases the cost of the picture, and for many pictures, the expense associated with having a trained photographer analyze and enhance the picture negatives is prohibitive.

With the introduction of digital cameras, the cost associated with analyzing and enhancing images has generally decreased. Digital processing techniques have been developed that allow a user to capture a digital image of an object and to efficiently view and manipulate features within the captured image via an input device, such as a mouse, for example. However, such digital processing techniques usually require the user to download the captured image into a computer system that includes image enhancement software. The image is displayed by the computer system, and the user then selects certain image features from the displayed image for digital enhancement by the image enhancement software.

Even though such digital image processing techniques have made image enhancement more efficient and user friendly, there still exists a finite amount of cost in employing the digital image processing techniques. More specifically, a user spends time and effort in selecting and manipulating the displayed image features that are enhanced. Thus, there exists a heretofore unaddressed need in the industry for simplifying and increasing the efficiency of image enhancement techniques.

### SUMMARY OF THE INVENTION

The present invention overcomes the inadequacies and deficiencies of the prior art as discussed hereinbefore. Generally, the present invention provides an image enhancing system and method for automatically detecting and manipulating data that defines a facial feature within a digital image in order to enhance an appearance of the facial feature.

In architecture, the image enhancing system of the present invention utilizes memory, a face detector, and an image enhancer. The memory stores digital data that defines a graphical image. The face detector analyzes the stored digital data and automatically identifies facial data within the digital data. This facial data defines an image of a person's face. The image enhancer analyzes the facial data and automatically identifies a portion of the facial data that defines a particular facial feature. The image enhancer then automatically manipulates the foregoing portion of the facial data in order to improve or enhance an appearance of the facial feature when the facial feature is displayed by a display device.

The present invention can also be viewed as providing a method for enhancing graphical images. The method can be broadly conceptualized by the following steps: receiving digital data defining a graphical image; automatically detecting facial data within the digital data; searching the facial data for data that defines a particular facial feature; automatically identifying, based on the searching step, a set of data defining the particular facial feature; and manipulating the set of data in response to the identifying step.

Other features and advantages of the present invention will become apparent to one skilled in the art upon examination of the following detailed description, when read in conjunction with the accompanying drawings. It is intended that all such features and advantages be included herein within the scope of the present invention and protected by the claims.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 depicts a block diagram that illustrates an image enhancing system in accordance with the present invention.

FIGS. 2 and 3 depict a flow chart that illustrates the architecture and functionality of a face detector depicted in FIG. 1.

FIG. 4 depicts a flow chart that illustrates the architecture and functionality of the image enhancing system depicted in FIG. 1.

### DETAILED DESCRIPTION OF THE INVENTION

The present invention generally relates to a system and method for automatically enhancing facial features within digital data that defines an image of a person. Since the image enhancement is automatic, relatively little training and/or effort is required to enable a user to produce more pleasing photographs.

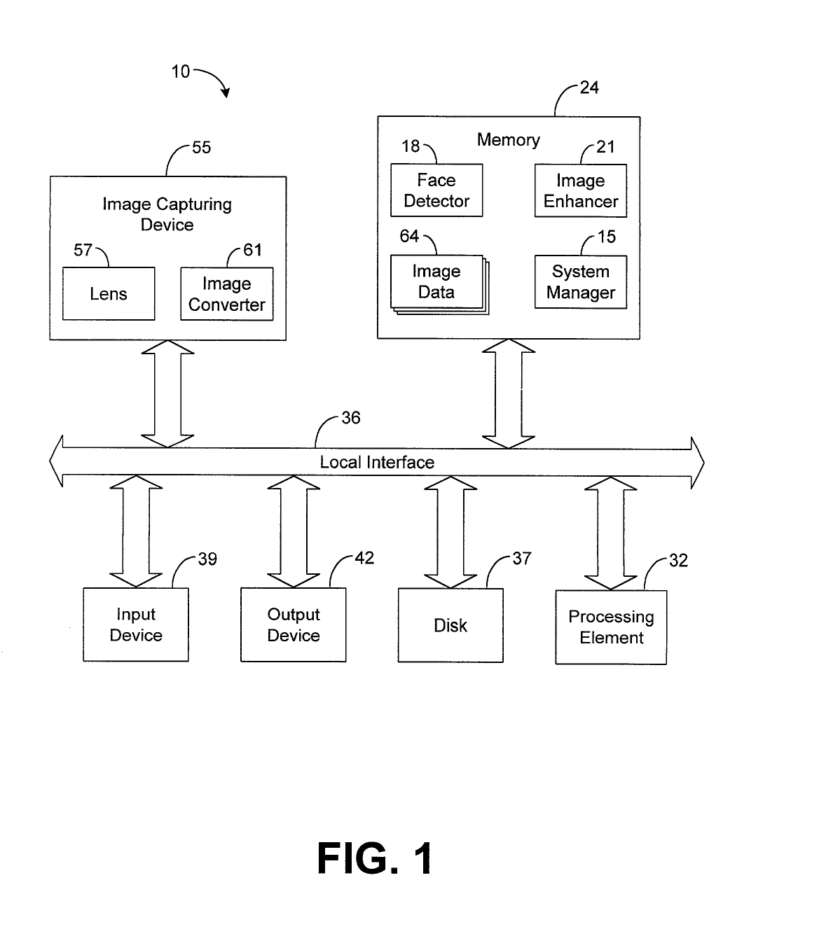

FIG. 1 depicts an image enhancing system 10 in accordance with the present invention. As shown by FIG. 1, the system 10 preferably includes a system manager 15, a face detector 18, and an image enhancer 21. The system manager 15, the face detector 18, and the image enhancer 21 can be implemented in software, hardware, or a combination thereof. In the preferred embodiment, as illustrated by way of example in FIG. 1, the system manager 15, the face detector 18, and the image enhancer 21 of the present invention along with their associated methodology are implemented in software and stored in memory 24 of the image enhancing system 10.

Note that the system manager 15, the face detector 18, and/or the image enhancer 21, when implemented in software, can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. As an example, the system manager 15, the face detector 18, and/or the image enhancer 21 may be magnetically stored and transported on a conventional portable computer diskette.

The preferred embodiment of the image enhancing system 10 of FIG. 1 comprises one or more conventional processing elements 32, such as a digital signal processor (DSP), that communicate to and drive the other elements within the system 10 via a local interface 36, which can include one or more buses. A disk storage mechanism 37 can be connected to the local interface 36 to transfer data to and from a nonvolatile disk (e.g., magnetic, optical, etc.). Furthermore, an input device 39 can be used to input data from a user of the system 10, and an output device 42 can be used to output data to the user. There are various devices that may be used to implement the input device 39 such as, but not limited to, a set (e.g., one or more) of switches, a set of buttons, a keypad, a keyboard, and/or a mouse. Furthermore, the output device 42 may be a liquid crystal display, a monitor, a printer, or any other conventional device for displaying an output.

In the preferred embodiment, the system 10 is implemented as a digital camera that is configured to take pictures via an image capturing device 55. In this regard, each component of FIG. 1 preferably resides within a portable housing, and the image capturing device 55 preferably includes a lens 57 for receiving and focusing light from a scene. The image capturing device 55 also includes a image converter 61 that is configured to convert the light into a set of digital data 64 that defines an image of the scene. This set of image data 64 may be transmitted to and stored within memory 24. As shown by FIG. 1, multiple sets of image data 64 respectively defining multiple pictures may be stored within memory 24.

In this regard, the input device 39 may include a button or other type of switch that, when activated, indicates that a picture should be taken. Upon activation of the button or other type of switch within input device 39, a set of image data 64 is transmitted to and stored within memory 24. This set of image data 64 defines an image exposed to the lens 57 approximately when the button or other type of switch was activated. The foregoing process may be repeated as desired. Each time the foregoing process is repeated, a new set of image data 64 defining an image exposed to the lens 57 is transmitted to and stored within memory 24. Note that it is possible to download one or more of the sets of image data 64 from an external device (not shown). For example, a disk may be interfaced with the system 10 via disk storage mechanism 37, and one or more sets of image data 64 may be downloaded into memory 24 from the disk.

It should be noted that it is not necessary for the system 10 to be implemented as a digital camera. For example, in another embodiment, the system 10 may be implemented as a desktop or laptop computer. In such an embodiment, the image capturing device 55 may be implemented as a detachable digital camera that acquires pictures as described above and that downloads the sets of image data 64 defining the pictures to memory 24. Alternatively, the image capturing device 55 may be implemented as a scanner that scans the surface of a document (e.g., a developed photograph) to define the sets of image data 64.

Other devices may be employed to implement the system 10. Indeed, any combination of devices that corresponds to the architecture of FIG. 1 for performing the functionality of the present invention, as described herein, may be employed to implement the system 10.

Once a set of image data 64 defining an image is stored in memory 24, the system manager 15 preferably invokes the face detector 18, which is configured to analyze the set of image data 64, as will be described in further detail hereafter. The system manager 15 may automatically invoke the face detector 18 when the system manager 15 detects the presence of the set of image data 64 within memory 24. Alternatively, a user may enter, via input device 39, an input indicating that the image defined by the set of image data 64 should be enhanced. In response to the input entered by the user, the system manager 15 invokes the face detector 18 and instructs the face detector 18 to analyze the set of image data 64 defining the image that is to be enhanced. As will be described in further detail hereafter, any face detected by the face detector 18 in analyzing the set of image data 64 may be automatically enchanced by the image enhancer 21.

Note that the input entered by the user for invoking the image enhancer 21 may include data that indicates which image defined by the image data 64 should be enhanced and, therefore, which set of image data 64 should be processed by the face detector 18 and image enhancer 21. For example, the system manager 15 may be configured to transmit one or more sets of image data 64 to output device 42, which displays the images defined by the sets of image data 64 transmitted to the output device 42. These images may be displayed consecutively or simultaneously by the output device 42. The user may then select, via input device 39, the image to be enhanced. In response, the system manager 15 instructs the face detector 18 to process the set of image data 64 defining the image selected by the user. If a face is defined by the selected set of image data 64, the image enhancer 21 is preferably invoked to enhance the image of the face. Thus, the user is able to select which sets of image data 64 are analyzed and enhanced by the system 10. Note that other techniques may be employed for enabling the user to select which set of image data 64 is to be enhanced and, therefore, processed by face detector 18 and image enhancer 21.

In analyzing a set of image data 64, the face detector 18 is configured to detect any portions of the image data 64 that defines a face of a person. Once the face detector 18 detects a face, the image enhancer 21 is invoked by system manager 15, and the image enhancer 21 utilizes the results of the face detector 18 to identify data defining certain personal features that can be enhanced by the image enhancer 21. Then, the image enhancer 21 manipulates the data defining these personal features to improve the appearance of the person depicted by the image defined by the image data 64.

As an example, it is common for wrinkles to develop on a person's face at the comers of the person's eyes. It may be desirable for these wrinkles to be blurred in a photograph of the person in order to improve the appearance of the person in the photograph. Based on the results of the face detector 18, the image enhancer 21 may be configured to automatically detect the aforementioned wrinkles and to automatically blur the pixel color values defining the wrinkles and the surrounding skin. In this regard, the image enhancer 21 is aware of which portion of the image data 64 defines a person's face based on the results of the analysis performed by the face detector 18. The image enhancer 21 may search this facial data for the data that defines the wrinkles that are to be blurred. As an example, the image enhancer 21 may first locate the data defining the eyes of the person by searching for white color values in the portion of the data defining the person's face. Once the eyes have been located, the image enhancer 21 may locate the data defining the wrinkles based on the data's pixel location relative to the data that defines the eyes. The image enhancer 21 may then blur or blend the color values of the pixels defining the wrinkles and the area around the wrinkles.

In another example, it may be desirable to change the color and/or brightness of a facial feature. For example, it may be desirable to shade the skin tone of a detected face to either brighten or darken the skin tone. The foregoing can be achieved by searching the facial data detected by the face detector 18 for pixel color values within a certain range. The certain range should be selected such that any facial pixel (i.e., a pixel within the facial data detected by face detector 18) having a color value within the range is likely to be a pixel that defines an image of the person's skin. Each facial pixel color value within the foregoing range may then be changed in order to shade the skin tone of the facial image of the person as desired.

In other examples, it may be desirable to sharpen or blur other features of the facial image defined by the image data 64. For example, the person's hair lines may be sharpened, and the person's cheeks and/or forehead may be blurred. In each of these examples, the image enhancer 21 is configured to analyze the facial data detected by face detector 18 and to locate the data defining a particular facial feature (e.g., skin, nose, mouth, eyes, etc.) based on the expected shape and/or color of the particular feature. The data defining this particular facial feature may be manipulated to enhance the person's appearance in the image defined by the image data 64, and/or the data defining a particular region of the person's face may be located, based on the region's pixel proximity from the particular feature, and manipulated to enhance the person's appearance in the image defined by the image data 64.

Since the image enhancer 21 is able to limit its search of the image data 64 to the portion that defines a person's face when attempting to locate a particular facial feature, the image enhancer 21 can be capable of locating the data defining the particular facial feature without user intervention. Moreover, if the image enhancer's search could not be so limited, then it is not likely that the image enhancer 21 would be able to successfully locate the particular facial feature. In this regard, numerous objects depicted in the image defined by the image data 64 may have similar attributes (e.g., color, shape, etc.) as the particular facial feature being sought. For example, the image enhancer 64 may search for white color values to locate the data defining a person's eyes. However, numerous objects (e.g., clouds, clothing, cars, etc.) depicted in the image may also have white color values. Thus, without limiting the search of the image data 64 to the portion defining the person's face, it would be difficult for the image enhancer 64 to automatically locate the data defining the region or feature that is to be enhanced. Thus, utilization of the face detector 18 for locating the data defining a person's face is an important feature for enabling automatic image enhancement. The architecture and functionality of the face detector 18 will now be described in more detail.

As previously set forth, the face detector 18 analyzes a set of image data 64 that defines a digital image and, based on the image data 64, detects if the digital image contains a face. If the digital image contains a number of faces, the face detector 18 detects and locates the data defining each of the faces, and the image enhancer 21 preferably attempts to enhance each detected face. The face detector 18 employs a face detection technology to detect if the digital image contains a face.

In one embodiment, the face detection technology used by the face detector 18 for face detection is the neural network-based face detection technology. The neural network-based face detection technology is disclosed in a publication entitled “Human Face Detection in Visual Scenes,” by H. Rowley, S. Baluja, and T. Kanade in November 1995. The publication is available from Carnegie Mellon University's Internet set at www.ius.cs.cms.edu/IUS/har2/www/CMU-CS-95-158R/. H. Rowley and S. Baluja further describe their face detection techniques in U.S. Pat. No. 6,128,397, which is incorporated herein by reference. In another embodiment, the face detection technology used by the face detector 18 for face detection is the principle component analysis-based face detection technology. This principle component analysis-based face detection technology is disclosed in U.S. Pat. No. 5,164,992, dated Nov. 17, 1992, and entitled “Face Recognition System,” which is incorporated herein by reference. Alternatively, other known face detection technologies may be used by the face detector 18.

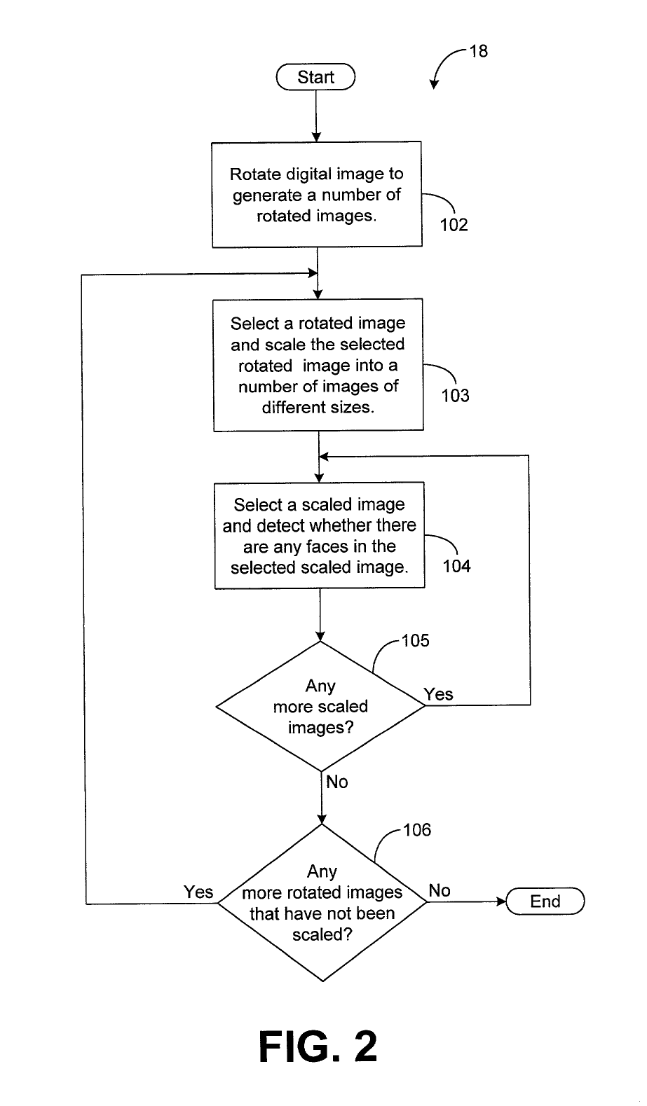

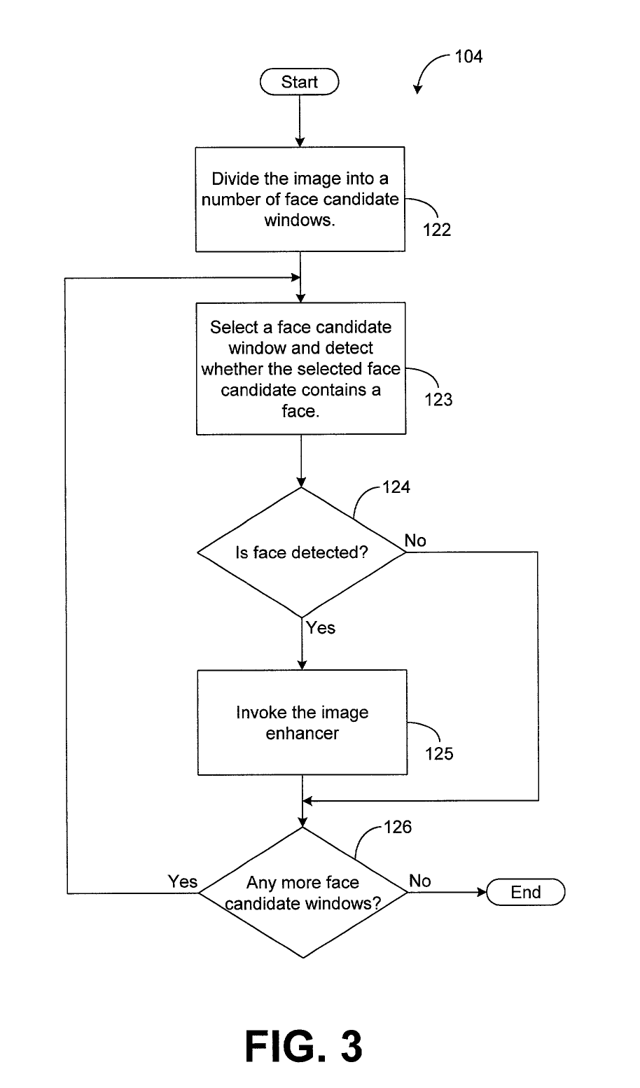

When the face detector 18 employs the neural network-based face detection technology, the face detector 18 detects if the digital image contains a face by dividing the digital image into a number of face candidate windows (not shown) and then detecting if each face candidate window contains a face by applying a set of neural network-based filters (also not shown) to each of the face candidate windows within the digital image. This is described in more detail in the above mentioned publication entitled “Human Face Detection in Visual Scenes.” In this case, the face candidate windows can be non-overlapping or overlapping. The filters examine each face candidate window in the digital image at several scales, looking for locations that might contain a face (e.g., looking for eye locations). The face detector 18 then uses an arbitrator to combine the filter outputs. The arbitrator is used to merge detections from individual filters and eliminate overlapping detections. As a result, the face detector 18 detects faces. Using the neural network-based face detection technology for the face detector 18 makes the face detection robust, relatively fast, and successful in detecting most faces. In addition, it allows the face detector 18 to detect different kinds of faces with different poses and lightings. FIGS. 2 and 3 depicts the architecture and functionality of the face detector 18 in an embodiment where the face detector 18 employs the neural network-based face detection technology.

As shown by block 102 of FIG. 2, the face detector 18 rotates the digital image defined by the image data 64 to generate a number of rotated images of the digital image. The purpose of rotating the digital image is to allow detection of faces at various orientations in the digital image. The number of rotated images is not critical to the present invention and may vary as desired.

At block 103, the face detector 18 selects one of the rotated images of the digital image and scales the selected image into a number of images of different sizes. At block 104, the face detector 18 selects one scaled image and then detects whether any faces are within the scaled image. At block 105, the face detector 21 determines if there are any more scaled images that have not been selected in block 103. If there are any such scaled images, block 104 is repeated. If there are no such scaled images, then block 106 is performed to determine if there are any more rotated images that have not been scaled for face detection. If the answer is yes, then the face detector 18 returns to block 103. If the answer is no, then the face detector 18 terminates processing of the image data 64 that is being analyzed.

Referring to FIG. 3, the face detector 18, to perform block 104, first divides the selected scaled image into a number of face candidate windows, as shown by block 122. As described above, the face candidate windows can be overlapping or non-overlapping. At block 123, the face detector 18 detects if a face candidate window contains a face. If it is determined that a face is detected at block 124, then block 125 is performed, at which point the image enhancer 21 is invoked to enhance one or more facial features of the detected face according to the techniques described herein. If, at block 124, it is determined that the face candidate window does not contain a face, then block 125 is skipped. If there are more undetected face candidate windows at block 126, the face detector 18 returns to block 123. Otherwise, the face detector 18 proceeds to block 105 of FIG. 2.

It should be noted that the image enhancer 21 may be configured to enhance certain facial features for each set of image data 64 processed by face detector 18 and image enhancer 21. This enhancement may be transparent to the user. For example, the image enhancer 64 may be configured to blur the color values of the data defining the cheeks within each face detected by face detector 18.

Alternatively, the user of the system 10 may be allowed to control which facial features are enhanced. For example, a list of options, such as an option for the blurring of wrinkles, an option for the blurring of cheeks, etc., may be displayed to the user via output device 42 (FIG. 1). The user may then select, via input device 39, which of the options the user wishes to have implemented. For example, the user may select the option for the blurring of cheeks. Based on the user's selection, the image enhancer 21 may be configured to locate the portion of the image data 64 defining a person's cheeks and to blur the color values within this portion of the image data 64. Without an input indicating that the user would like the cheeks blurred, the image enhancer 21 may be configured to refrain from blurring the data defining the cheeks. In such an embodiment, the user may control the type of image enhancement performed by the image enhancer 21, but the detection of the data defining the particular feature or region to be enhanced and the enhancement of this data are performed automatically without user intervention.

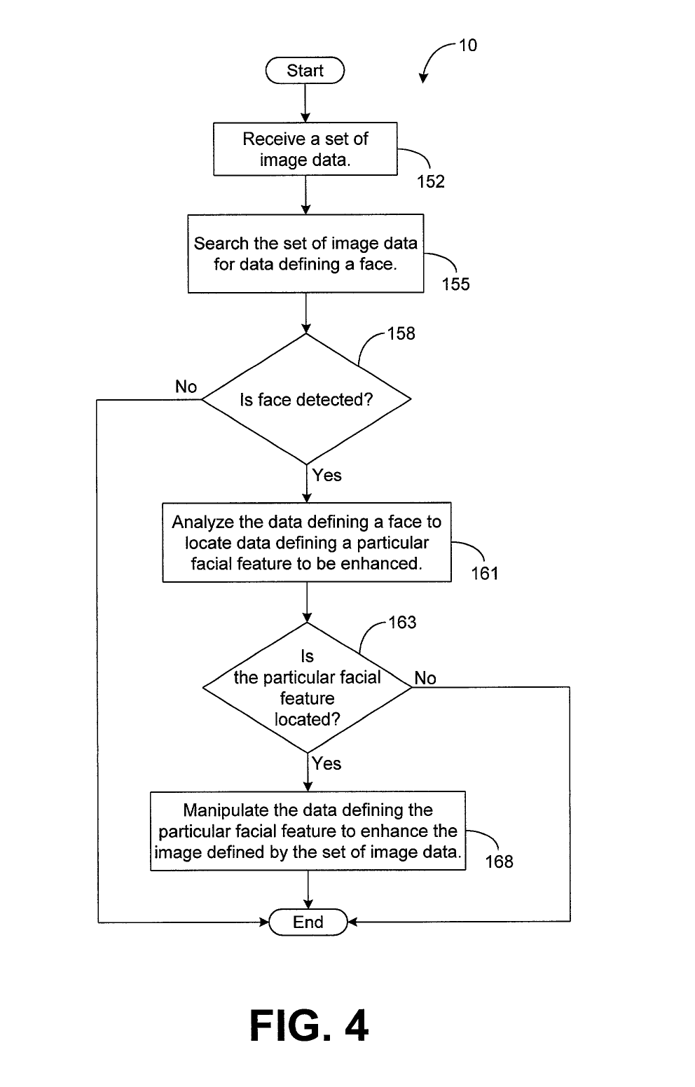

The preferred use and operation of the image enhancement system 10 and associated methodology are described hereafter with reference to FIG. 4. For illustrative purposes, assume that the image enhancement system 10 is configured to automatically detect and compensate for facial blemishes (e.g., pimples) that are depicted on an image of a person's face. However, it should be noted that it is possible for the system 10 to be configured to detect other types of facial features and to enhance the image of a person according to other types of methodologies.

In block 152, a set of image data 64 that defines an image of a person is stored into memory 24. The set of data 64 may be the data produced by the image capturing device 55 in capturing an image of a scene. After the set of image data 64 is received in block 152, the face detector 18 analyzes the set of image data 64 to detect a portion of the image data 64 that defines an image of a person's face, as shown by block 155. Once the data defining a person's face is detected, the image enhancer 21 analyzes the facial data to locate automatically the data defining a facial blemish, as shown by blocks 158 and 161. Location of the data defining the facial blemish may be accomplished via a variety of techniques, including the comparison of pixel colors within the facial data.

Once the data defining the facial blemish has been located, the image enhancer 21 automatically manipulates the facial blemish data to enhance the appearance of the image defined by the facial data, as shown by blocks 165 and 168. For example, the image enhancer 21 may shade the pixel color values of the facial blemish data to colors similar to the pixel color values of the other portions of facial data. Thus, the facial blemish defined by the facial blemish data is compensated. In this regard, when an image defined by the facial data is displayed, the facial blemish defined by the facial blemish data should be relatively difficult to detect due to the automatic enhancement performed by the image enhancer 21. As a result, the appearance of the image should be more pleasing to view.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Now, therefore, the following is claimed:

1. An automatic image enhancement system, comprising:
memory for storing digital data that defines a graphical image;
a face detector configured to analyze said digital data and to automatically identify facial data within said digital data stored in said memory; and
an image enhancer configured to analyze said facial data identified by said face detector and to automatically identify a portion of said facial data that defines a particular facial feature, said image enhancer further configured to automatically manipulate said portion for enhancing an appearance of said facial feature within said graphical image.

2. The system of claim 1, wherein said system further comprises an input device configured to receive an input, wherein said image enhancer is further configured to select said facial feature based on said input.

3. The system of claim 1, wherein said image enhancer manipulates said portions by blending color values associated with said portion.

4. The system of claim 1, wherein said image enhancer, by manipulating said portion, blurs said appearance of said facial feature.

5. The system of claim 1, wherein said image enhancer, by manipulating said portion, sharpens said appearance of said facial feature.

6. The system of claim 1, wherein said image enhancer, by manipulating said portion, changes a color of said facial feature.

7. The system of claim 1, wherein said system includes an image capturing device configured to receive an image of a scene and to produce said digital data based on said image received by said image capturing device.

8. The system of claim 7, wherein said image capturing device includes a lens for receiving said image and an image converter for producing said digital data based on said image.

9. An automatic image enhancement system, comprising:
means for storing digital data that defines a graphical image;
face detecting means for analyzing said digital data and for automatically identifying facial data within said digital data stored in said storing means; and
image enhancing means for analyzing said facial data identified by said face detecting means, for automatically identifying a portion of said facial data that defines a particular facial feature, and for automatically manipulating said portion to enhance an appearance of said facial feature within said graphical image.

10. A method for enhancing graphical images, comprising the steps of:
receiving digital data defining a graphical image;
automatically detecting facial data within said digital data;
searching said facial data for data that defines a particular facial feature;
automatically identifying, based on said searching step, a set of data defining said particular facial feature; and
manipulating said set of data in response to said identifying step.

11. The method of claim 10, wherein said manipulating step includes the step of blending color values within said set of data with other color values within said facial data.

12. The method of claim 10, further comprising the steps of:
receiving an input; and
selecting said particular facial feature based on said input,
wherein said searching step is based on said selecting step.

13. The method of claim 10, wherein said manipulating step causes a blurring of an appearance of said particular facial feature when said particular facial feature is displayed.

14. The method of claim 10, wherein said manipulating step causes a sharpening of an appearance of said particular facial feature when said particular facial feature is displayed.

15. The method of claim 10, wherein said manipulating step affects a color of said particular facial feature when said particular facial feature is displayed.

16. The method of claim 10, further comprising the steps of:
capturing an image of a scene; and
defining said digital data based on said capturing step.

17. The method of claim 16, wherein said capturing step includes the steps of: receiving light via a lens; and
converting said light into said digital data received in said receiving step.
